(19) United States
(12) Patent Application Publication
(10) Pub. No.: US 2005/0180434 A1
(43) Pub. Date: Aug. 18, 2005

(54) Generic support of telephony supplementary services for voice over internet protocol

(75) Inventors: Matia Marcu, Natanya (IL); Michael Rabinovich, Modiin (IL); Boris Pruss, Rosh-Haain (IL)

Correspondence Address: Fogg and Associates, LLC, P.O. Box 581339, Minneapolis, MN, 55458-1339, US

(73) Assignee: ADC Telecommunications Israel Ltd.

(21) Appl. No.: 10/777,945

(22) Filed: Feb. 12, 2004

(51) Int. Cl. H04L 12/28

(52) U.S. Cl. 370/401

(57) ABSTRACT

A Voice Over Internet Protocol gateway support of supplementary services in a communication system. In one embodiment, a gateway includes a main state machine that is adapted to process a plurality of different type supplemental services with a single process.

### TECHNICAL FIELD

The present invention relates generally to the field of telecommunications and in particular Voice Over Internet Protocol gateway support of supplementary services.

### BACKGROUND

The modem telephone system was primarily designed to transport voice signals between terminals at remote locations. Conventionally, the telephone system makes connections and routes calls through a network using switches and other electronic equipment. Prior to the 1960s, the telephone system used primarily analog switches and other analog equipment. With the increasing capability of computer systems and other digital electronics, the telephone system began to include digital switches and other equipment. For example, Digital Loop Carriers (DLCs) were developed to allow connections from a number of subscribers to be routed to a location remote from the central office and then connected to the central office over a high speed, digital line. Again, however, this digital equipment was primarily designed to handle voice signals.

Over time, telecommunications systems have been used to carry data, other than voice signals, between terminals at remote locations as well. Transporting data has posed a variety of problems for conventional telephone systems. For example, as mentioned, the telephone system was designed to carry low bandwidth voice traffic. Unfortunately, these low bandwidth channels can provide a significant obstacle to providing higher bandwidth data services that have become so popular, e.g., the Internet and other data networks.

To capture a portion of this data market, the telephony industry developed a group of technologies known collectively as “Digital Subscriber Line” (DSL) services, e.g., Asymmetrical Digital Subscriber Line (ADSL), High-Bit Rate Digital Subscriber Line (HDSL), Rate Adaptive Digital Subscriber Line (RADSL), Symmetric Digital Subscriber Line (SDSL), etc. These services provide high speed connections over existing copper wires used to carry conventional telephone traffic. These services use various modulation schemes and other techniques to allow the data to be transmitted over the existing copper lines at higher speeds.

Unfortunately, DSL voice traffic is not directly compatible with conventional equipment in the Public Switched Telephone Network (PSTN). For example, DSL voice traffic conventionally is incorporated in Asynchronous Transfer Mode (ATM) packets or cells. This is different from the Time Division Multiplexing (TDM) format associated with the PSTN. Further, the ATM packets are not directly compatible with signaling and other requirements of the PSTN. Therefore, a specialized voice gateway is placed at the point in the network that DSL voice traffic, e.g., from a number of DLCs, is to enter the PSTN. This voice gateway provides translation between ATM and TDM formats as well as processing the signaling and other functions required by network standards, e.g., GR-303 in North America, V5 in the International market, to prepare the voice traffic for transmission over the PSTN. This allows the transfer of data and voice traffic between internet networks and PSTN.

Internet protocols are typically software used in gateways to track internet addresses of nodes, route outgoing messages and recognizes incoming messages. A Voice Over Internet Protocol (VOIP) gateway allows voice traffic to be transmitted over a data network using the internet protocols. Currently, VoIP gateways require separate software processes for supplementary services associated with voice traffic such as caller Id, visual message waiting and the like. The use of separate software processes for the supplemental services leads to a waste of processing time and memory resources. In order to reduce the waste, some manufactures select only a subset of supplemental services. This however, leads to partial coverage of such services. An efficient way of handling supplemental services without the use of separate software functions is needed in the art.

For the reasons stated above, and for other reasons stated below which will become apparent to those skilled in the art upon reading and understanding the present specification, there is a need in the art for an efficient way of handling supplemental services without the use of separate software functions.

### SUMMARY

The above-mentioned problems as well as other problems are addressed by embodiments of the present invention and will be understood by reading and studying the following description.

In one embodiment, a gateway in a communication system is disclosed. The gateway includes a main state machine that is adapted to process a plurality of different type supplemental services with a single process.

In another embodiment, a voice over IP gateway for a telecommunication system is disclosed. The gateway includes a main state machine and a secondary state machine. The main state machine is adapted to process a plurality supplemental services. The secondary state machine is adapted to control the polarity of a transmission line. Moreover, the secondary state machine being controlled by the main state machine.

In further another embodiment, a method implementing a voice over IP gateway in a communication system is disclosed. The method comprises supporting a plurality of different types of supplemental services with a single process.

In yet another embodiment, a method of providing a plurality of supplemental services through a voice over IP gateway is disclosed. The method comprises receiving a supplemental service signal. Computing a process variable based on the supplemental service signal. Converting the process variable and a select input into a unique event signal. Processing the unique event signal. Sending a signal to a select terminal equipment based on the processed unique event signal and providing associated supplemental service data to the select terminal equipment.

In still yet another embodiment, a computer-usable medium having computer-readable instructions stored thereon for execution by a processor to perform a method is disclosed. The method comprising supporting a plurality of different types of supplemental services with a single process.

### BRIEF DESCRIPTION OF THE DRAWINGS

The present invention can be more easily understood and further advantages and uses thereof more readily apparent, when considered in view of the description of the preferred embodiments and the following figures in which:

FIG. 1 is a block diagram of a communication system that includes a gateway of one embodiment of the present invention;

FIG. 2 is a block diagram of a gateway of one embodiment of the present invention;

FIG. 3 is a state diagram of a main state machine of one embodiment of the present invention;

FIG. 4 is a timing graph illustrating the timing of an example of a process through the main state machine of one embodiment of the present invention;

FIG. 5 is state diagram of the process corresponding to the timing graph of FIG. 4;

FIG. 6 is a timing graph illustrating the timing of an example of a process that involves both the main state machine and the secondary state machine of one embodiment of the present invention; and

FIG. 7 is state diagram of the process corresponding to the timing graph of FIG. 6.

In accordance with common practice, the various described features are not drawn to scale but are drawn to emphasize specific features relevant to the present invention. Reference characters denote like elements throughout Figures and text.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

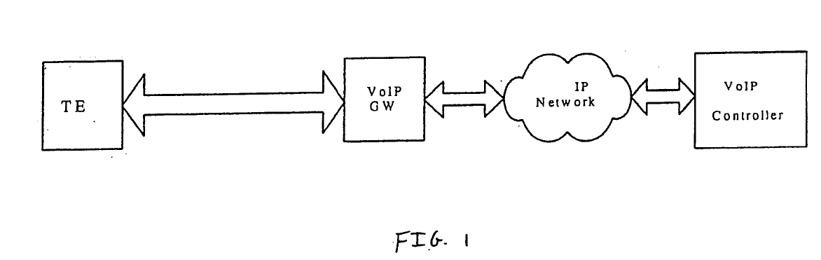

Embodiments of the present invention provide a method by which a Voice Over Internet Protocol (VOIP) gateway (GW) can support multiple supplementary services according to the requirements of any terminal, any operator and any country. Moreover, the present invention supports the whole range of services and signals by a unique implementation. This offers full requirements coverage with maximum flexibility and minimal resources. Referring to FIG. 1, one embodiment of a telecommunication system 100 of the present invention is illustrated. As illustrated, the telecommunication system 100 includes a VoIP Controller 102, an IP Network 104, a VoIP GW 106 and terminal equipment (TE) 108. In operation, VoIP controller 102 (which may be referred to as a softswitch, call agent, media gateway controller or gatekeeper) sends messages to VoIP GW 106 via IP network 104. Each message contains information needed to support a certain service such as calling party identity or caller ID. In one embodiment of the present invention, the VoIP GW 106 process and converts the messages into terminal alerting signals and then passes the terminal alerting signals to TE 108. TE 108 then processes the terminal alerting signals and sends an acknowledgement signal back to VoIP GW 106. Data associated with a terminal alerting signal is then passed on the TE 108 by the VoIP GW 106.

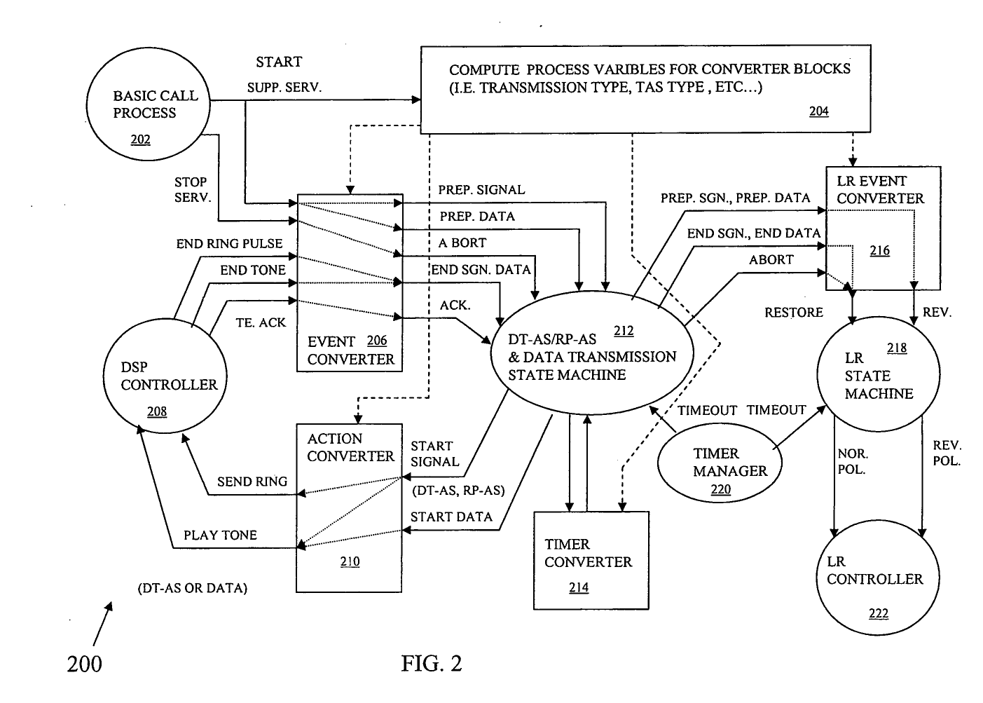

There are a variety of terminal alerting signals. They include Dual Tone Alerting System (DT-AS), Ring Pulse Alerting Signal (RP-AS), Line (polarity) Reverse (LR), LR followed by DT-AS or the like. As stated above, embodiments of the present invention provide a universal method by which a VoIP gateway can handle support supplementary services. Referring to FIG. 2, a block diagram 200 of one embodiment of a VoIP gateway 200 of the present invention is illustrated. As illustrated, this embodiment includes a main DT-AS/RP-AS and Data transmission state machine 212 (main state machine 212) and a secondary LR state machine 218 (secondary state machine 218). The main state machine 212 is adapted to cover DT-AS/RP-AS and data transmission scenarios for services. The secondary state machine 218 is adapted to cover all the polarity restore options on time out, after end terminal equipment alerting signal (TAS) and after end of data. The processes of the secondary state machine 218 are synchronized with the processes of the main state machine 212.

Also illustrated in FIG. 2 is an event converter 206. Generally, the event converter receives messages from other software entities and converts the received messages based on the type of terminal alerting signal into unique events for the main state machine 212. An action converter 210 is coupled to receive results given by the main state machine 212. In particular, the action converter 210 converts the outputs of the main state machine to either a send ring command or a play tone command which are received by a digital signal processing (DSP) controller 208. The DSP controller 208 activates the relevant DSP using the appropriate parameters. In one embodiment, the DSP controller 208 is used to provide a power ringing signal. In another embodiment, the DSP controller 208 provides tone signals such as DT-AS, frequency shift keying (FSK) and dual tone multi-frequency (DTMF). In further another embodiment (not shown), separate DSPs are provided to cover both the power ring signal and the tone signals. The LR event converter 216, the secondary state machine 218 and the LR controller 222 work together to control the polarity reversal for supplemental serves that require a polarity reversal. In particular, the LR event converter 216 converts signals from the main state machine 216 into restore and reverse signals that are coupled to the secondary state machine 218. The LR controller 222 is coupled to the secondary state machine 218 to control normal or reverse polarity of the line. As stated above the secondary state machine 218 is synchronized with the main state machine 212 and the line polarity reversal is controlled by the commands coming from the main state machine 212. Periods of time out of the main state machine 212 and the secondary state machine are controlled by timer manager 220. Moreover, timer converter 214 is used by the main state machine 212 to process its outputs. FIG. 2 also illustrates, a pre-processing controller 204 that is coupled to receive a start of supplemental service signals from a basic call process 202. In particular, the pre-processing controller is used to compute process variables for the converter blocks (i.e. the event converter 206, the action converter 210 and the LR event converter 216).

In one embodiment of the present invention, the main state machine 212 covers seven different states and six different events. That is, the main state machine processes and provides outputs dictated by a set of states and events. An example of states and events are illustrated in Table 1.

TABLE 1

| | State | | | | | | |
|---|---|---|---|---|---|---|---|
| | | | | | | | Post- |
| Event | Idle 0 | Pre-Sgn 1 | Sgn 2 | WtAck 3 | Pre-Data 4 | Data 5 | Data 6 |
| PrepSgn | 1 | — | — | — | — | — | — |
| | t=t1 | | | | | | |
| | Enter | | | | | | |
| | LRH(-) | | | | | | |
| EndSgn | — | — | If | — | — | 6 | — |
| Data | | | onhook | | | t=t7 | |
| | | | 4, t=t3 | | | LRH(D) | |
| | | | LRS(S) | | | | |
| | | | else 3 | | | | |
| | | | t=t4 | | | | |
| Ack | — | — | — | 4 | — | — | — |
| | | | | t=t5 | | | |
| PrepData | 4 | — | — | — | — | — | — |
| | t=t2 | | | | | | |
| | Enter | | | | | | |
| | LRH(-) | | | | | | |
| Timeout | — | 2 | — | 6 | 5 | — | 0 |
| | | t=0 | | t=t6 | t=0 | | t=0 |
| | | SndSgn | | — | SndData | | Exit |
| Abort | 0 | 0 | 0 | 0 | 0 | 0 | 0 |
| | t=0 | t=0 | t=0 | t=0 | t=0 | t=0 | t=0 |
| | | LRH(-) | StopSgn | LRH(-) | LRH(-) | StopData | Exit |
| | | Exit | LRH(-) | Exit | Exit | LRH(-) | |
| | | | Exit | | | Exit | |

As illustrated in Table 1, the states include Idle, Pre-Sgn, Sgn, WtAck, Pre-Data, Data and Post-Data. The Idle state is a state where no supplemental services have been activated. The Pre-Sgn state is a select time out used before sending DT-AS/RP-AS data. The Sgn state is a state that sends the DT-AS/RP-AS data. The Pre-Data (or Pre-Dat) is another select time out before sending the supplemental services data. The Data state is a state that sends the supplemental service data. The Post-data state is a state that performs a select time out after the end of data transmission and before supplemental services deactivation and the WtAck state is a state that waits for terminal equipment (TE) acknowledgement, which in one embodiment is only used for off hook transmission.

The events of Table 1 include PrepSgn, EndSgnData, Ack, PrepData, Timeout and Abort. The PrepSgn event prepares the DT-AS/RP-AS signal to be sent. The EndSgnData event signifies the end of the DT-AS/RP-AS/data transmission. The Ack event is an event that seeks TE conformation during offhook transmission for supplemental services such as caller id during call waiting. The PreData event prepares the DT-AS/RP-AS data to be sent. The timeout event is a time out period and the Abort event processes the ceasing of the process.

In one embodiment of the present invention, the secondary state machine 218 has two states and three events. The states and events of the secondary state machine 218 are illustrated in table 2.

TABLE 2

State

| Event | Idle 0 | Reversed 1 |
|---|---|---|
| Reverse | 1 | — |
| | t_lr = t8 | |
| Restore | — | 0 |
| | | t_lr = 0 |
| | | NormBat |
| Timeout | — | 0 |
| | | t_lr = 0 |
| | | NormBat |

As indicated in Table 2, the states of the secondary state machine 218 in this embodiment include an idle state and a reversed state. The events include a reverse event, a restore event and a timeout event.

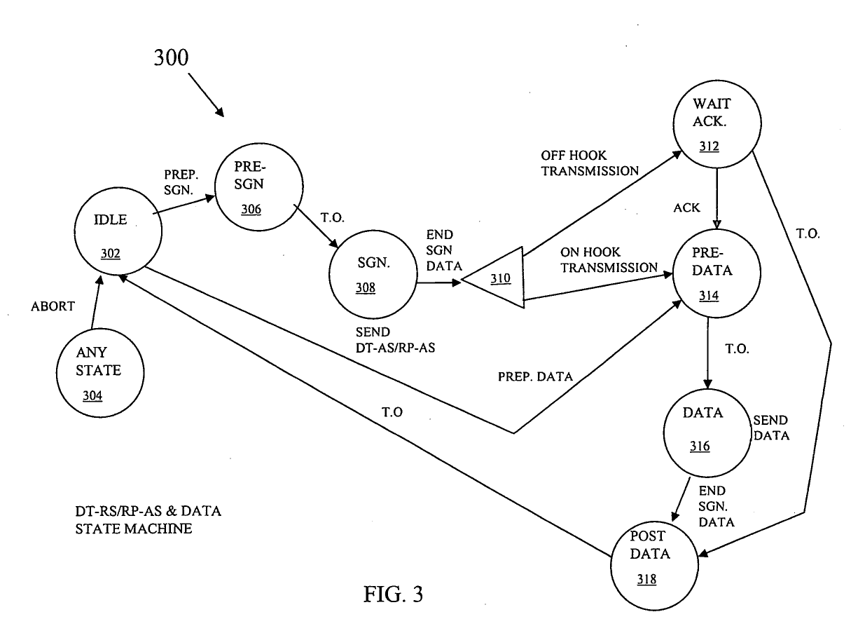

To provide a better understanding of the present invention, an example of a basic call process implementing one embodiment of the present invention is now described. Referring back to FIG. 2, the necessary service commands are sent from the basic call process 202 to the event converter (206). For this example, the event converter 206 outputs a PrepSgn signal to the main state machine 212. Turning to FIG. 3, a state diagram illustrating the functions of the main state machine 212 in one embodiment is illustrated. Once the PrepSgn is received, the main state machine 212 changes from an idle state 302 to a Pre-Sgn state 306. As stated above, the Pre-Sgn state observes a select amount of time before sending an initial ring or other type of terminal alerting signal. The period of the select amount of time is determined by standards relating to the services provided and may even be zero in some cases (in this example, the timer is set to 1 during the Pre-Sgn state 306). After the timeout period expires, the state is changed to a Sgn state 308 in which the alerting signal is passed to the terminal equipment. Once the terminal equipment has been alerted, an EndSgnData end signal data is sent by the Sgn State 308 to branch state 310. In this state 310, paths to different states are determined by the particular service that is being implemented. That is, there is one path for services associated with off hook transmission requirements and another path for services associated with on hook transmissions.

For the services associated with the off hook transmission requirements, the off hook transmission path is taken to the Wait Ack State 312. In particular, service that requires the acknowledgement from an associated terminal equipment follow the path the Wait Ack State 312. At the Wait Ack State 312, the system waits for an acknowledgement from an associated terminal equipment. If no acknowledgement is received from the terminal equipment, a path to the Post Data state 318 is taken and after a certain amount of time (according to predefined standards) the method moves to the idle state 302. If acknowledgement is received, a Pre-Data 314 state performs a time out of a select period of time based on the predefined standards. After the select time has past, the data state 316 sends the service information (data) to the associated terminal equipment. Upon completion of sending the service information, a post data state 318 provides a select time out period. After the post data state, the method is returned to the idle state 302. In another example, illustrated in FIG. 3, a path is taken directly from the idle state 302 to the Pre-Data state 314. This example is illustrates a case of dual tone multi-frequency (DTMF) caller id. A DTMF transmission uses as TAS an LR signal. In this type of service, there is no preliminary signal to the terminal but a time out. Also illustrated in FIG. 3, is “any state” 304. The any state 304 is used to indicate that an abort signal has been received. The any state 304 ends a process and changes the state to the idle state 302.

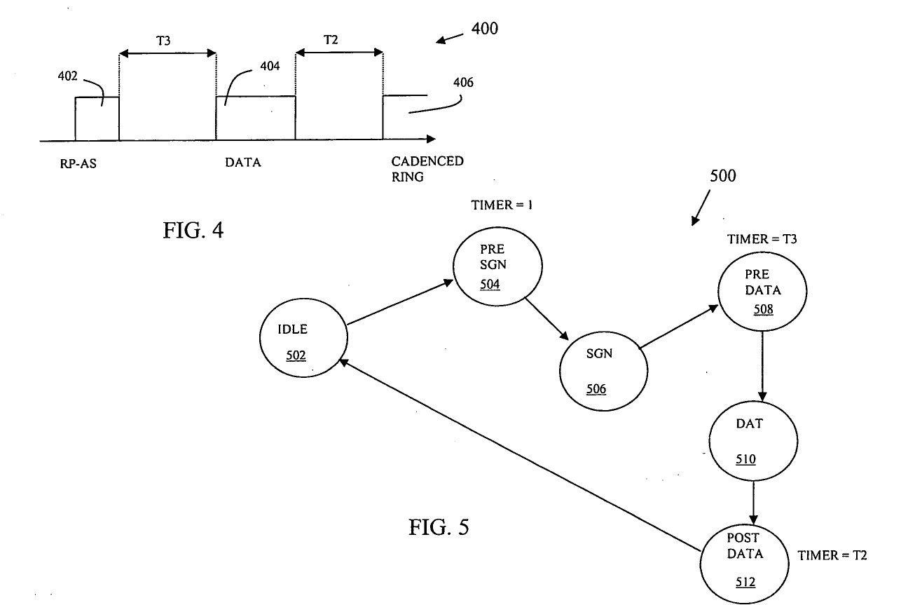

Referring to FIGS. 4 and 5, an example of a method of handling caller id service with a main state machine 212 of one embodiment of the present invention is illustrated. As illustrated in the graph of FIG. 4, a ring pulse alerting signal (RP-AS) 402 pulse is applied and after T3 the data 404 is sent. After T2, a cadenced ring 406 to the terminal is sent. The state diagram of FIG. 5 illustrates the steps taken by the state machine for this service. As illustrated, from the idle state 502, the process goes to the Pre-Sgn state 504 with the timer=1. The initial ring is then sent in the Sgn state 506. The process then goes to the Pre Data state 508 which waits for a period of T3. The Data 404 is the sent by the Data state 510. Once the Data 404 has been sent, the process goes to the Post Data state 512 which waits for a period of T2. A cadenced ring 406 is then sent and the state machine 212 then goes back to the idle state 502.

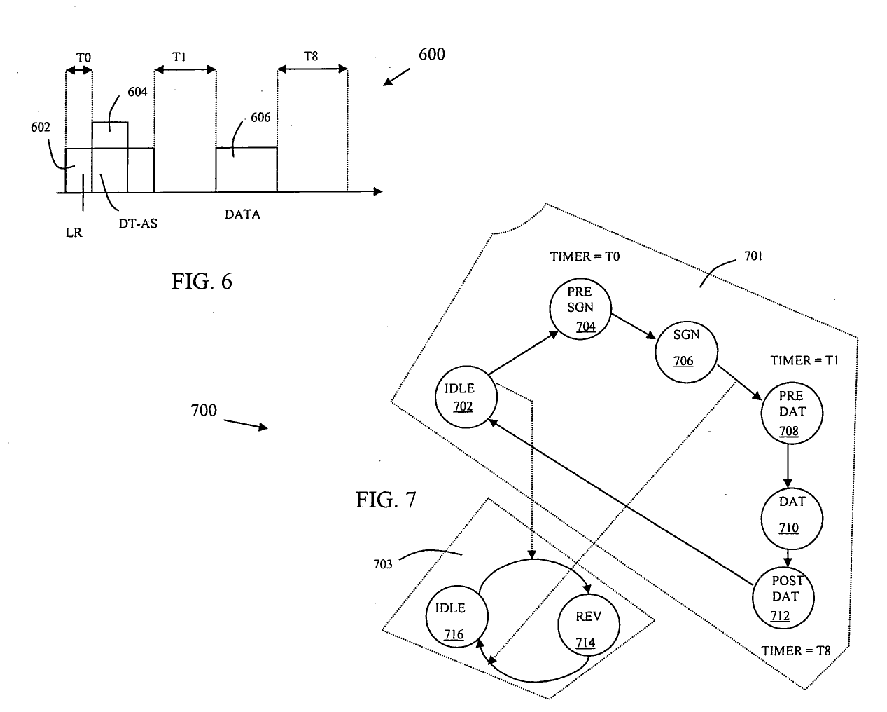

Another example of another services handled with a gateway of one embodiment of the preset invention is referenced in FIGS. 6 and 7. In this example, the service is visual message waiting indication (VMWI) service which uses a polarity reversal pulse and a dual tone alerting system (DT-AS). This example further illustrates the coordinating between the processes of the main state machine 701 and the processes of the secondary state machine 703.

Referring to FIG. 6, a graph illustrating the timing of this embodiment is shown. As illustrated, at the beginning, the LR signal 602 is started. After time period TO, the DT-AS signal 604 starts. Moreover, as indicated, the LR signal 602 continues through the period of the DT-AS 604. When the LR signal 602 ends Ti is started. At the end of Ti, the data signal 606 is sent. When the data signal 606 ends, T8 is started. FIG. 7 illustrates a state diagram 700 of the process of the main state machine 701 and the process of the secondary state machine 703 for this service in this embodiment of the present invention. A DT-AS signal is sent from an idle state 702 to a Pre-Sgn state 704. Moreover, as shown, from the idle state 702, a line reverse LR signal is also sent to the secondary state machine 703 going from the Idle state 716 to a Rev state 714 to reverse the polarity state of a line going to an associated TE. As indicated, the Pre-Sgn state 704 is at TO. At the Sgn state 706, the DT-AS signal is sent to an associated TE. Also indicated, is from the Sgn state 706 to the Pre-data state 708, a signal is send to the secondary state machine 703 going from the Rev state 714 to the Idle state 716 to return the line to the normal polarity state. The Pre Data state 708 occurs during Ti. The Data state 710 sends the data to the TE. After the Data related to the service has been sent, a Post Data state 712 occurs. As indicated, the Post Data state occurs during T8. The process then returns to the Idle State 702.

Referring to Table 3, a table illustrating the outputs of the event converter 206 for given supplemental service types and inputs of one embodiment of the present invention is illustrated. As illustrated, the supplemental service types are indicated by a terminal equipment alerting signal (TAS) supplied by the pre-processing controller 204.

TABLE 3

| | TAS Type | | | | | |
|---|---|---|---|---|---|---|
| | | | LR + | | LR + | DT-AS- |
| Input | DT-AS | RE-AS | DT-AS | LR | RP-AS | Offh |
| SartServ | PrepSgn | PrepSgn | PrepSgn | PrepData | PrepSgn | PrepSgn |
| End Ring | — | EndSgn | — | — | EndSgn | — |
| Pulse | | Data | | | Data | |
| End | EndSgn | EndSgn | EndSgn | EndSgn | Endsgn | EndSgn |
| Tone | Data | Data | Data | Data | Data | Data |
| Ack | — | — | — | — | — | Ack |
| StopServ | Abort | Abort | Abort | Abort | Abort | Abort |

The outputs of the LR Event converter 216 of one embodiment are illustrated in Table 4. As indicated the output is based on the LR type supplied by the pre-processing controller 204 and inputs.

TABLE 4

LR Type

| | | | Restore | Restore |
|---|---|---|---|---|
| Inputs | No LR | Pulse | After Sgn | After Data |
| PrepSgn | — | Reverse | — | — |
| PrepData | — | Reverse | — | — |
| EndSgnData | — | — | Restore | — |
| S(=EndSgn) | | | | |
| EndSgnData | — | — | — | Restore |
| D(=EndData) | | | | |
| Ack | — | — | — | — |
| Abort | — | Restore | Restore | Restore |

The outputs of the action converter 210 of one embodiment of the present invention are illustrated in Table 5. As indicated the output is based on the type of TAS and inputs from the main state machine 212.

TABLE 5

| | TAS Type | | | | | |
|---|---|---|---|---|---|---|
| Input | DT-AS | RP-AS | LR + DT-AS | LR | LR + RP-AS | DT-AS-Offh |
| Start | Play tone | Send ring | — | — | Send | Play tone |
| Signal | (DT-AS) | | | | Ring | (DT-AS) |
| Start | Play tone | Play tone | Play tone | Play tone | Play tone | Play tone |
| Data | (data) | (data) | (data) | (data) | (data | (data) |

An example of timer values of the TAS types for each functional timer of one embodiment of the present invention is illustrated in Table 6. Examples of timer values depending on transmission type for a functional timer of one embodiment of the present invention is illustrated in Table 7. Moreover, examples of timer values of each line reverse type for a functional timer of one embodiment of the present invention is illustrated in Table 8.

TABLE 6

| | TAS Type | | | | | |
|---|---|---|---|---|---|---|
| | | | LR + | | LR + | DT-AS- |
| Timer | DT-AS | RP-AS | DT-AS | LR | RP-AS | Offh |
| t1 | 1 | 1 | T0 | — | T0 | T10 |
| t2 | — | — | — | T7 | — | — |
| t3 | T4 | T3 | T1 | — | T1 | — |
| t4 | — | — | — | — | — | T14 |
| t5 | — | — | — | — | — | T12 |
| t6 | — | — | — | — | — | T9 |

TABLE 7

| | TransType | | |
|---|---|---|---|
| | offhook | Offhook | |
| Timer | with ring | Without ring | Offhook |
| t7 | T2 | T8 | T13 |

TABLE 8

| | LR Type | | | |
|---|---|---|---|---|
| | | | Restore | Restore |
| Timer | No LR | Pulse | After Sgn | After Data |
| t8 | — | Tp (represents | 0 | 0 |
| | | the value of the | | |
| | | provisional LR | | |
| | | pulse) | | |

A description of functional timer values of one embodiment of the present invention are as follows; t1 is the time period from supplemental service (SuppServ) activation till start of DT-AS/RP/AS transmission, t2 is the time period from SuppServ activation till start of data transmission, t3 is the time period from the end of DT-AS/RP/AS till start of transmission, t4 is a wait period for acknowledgement (Ack) after the end of DT-AS, t5 is the time from Ack till the start of data transmission, t6 is the time period from t4 timeout until SuppServ deactivation, t7 is the time period from the end of data transmission till SuppServ deactivation and t8 is the line reverse (LR) pulse time. In addition in one embodiment, the timer tables are dynamically built according to the provisioning type, while all other tables are hard-coded.

The methods and techniques described here may be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented on a programmable system including at least one programmable processor coupled to receive data and instructions from, and to transmit data and instructions to, a data storage system, at least one input device, and at least one output device. Generally, a processor will receive instructions and data from a read-only memory and/or a random access memory. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and DVD disks. Any of the foregoing may be supplemented by, or incorporated in, specially-designed application-specific integrated circuits (ASICs).

Although specific embodiments have been illustrated and described herein, it will be appreciated by those of ordinary skill in the art that any arrangement, which is calculated to achieve the same purpose, may be substituted for the specific embodiments shown. This application is intended to cover any adaptations or variations of the present invention. Therefore, it is intended that this invention be limited only by the claims and the equivalents thereof.

1. A gateway in a communication system, the gateway comprising:
a main state machine adapted to process a plurality of different type supplemental services with a single process.

2. The gateway of claim 1, further comprising:
an event converter adapted to convert received messages based on a type of terminal alerting signal into unique events for the main state machine.

3. The gateway of claim 1, further comprising:
an action converter adapted to convert outputs of the main state machine to either a send ring command or a play tone command.

4. The gateway of claim 1, wherein the plurality of types of supplemental services are selected form a group consisting of dual tone alerting signal (DT-AS), ring pulse alerting signal (RP-AS), line reverse+dual tone alerting signal (LR+DT-AS), line reverse (LR), line reverse+ring pulse alerting signal (LR+RP-AS) and dual tone alerting signal−off hook (DT-AS−Offh).

5. The gateway of claim 1, further comprising:
a secondary state machine adapted to process supplemental services related to line polarity, the secondary state machine being under the control of the main state machine.

6. The gateway of claim 5, further comprising:
a line reverse event converter adapted to convert signals from the main state machine into restore and reverse signals that are coupled to the secondary state machine.

7. The gateway of claim 5, further comprising:
a line reverse controller coupled to the secondary state machine and adapted to control the polarity of communication lines.

8. A voice over IP gateway for a telecommunication system, the gateway comprising:
a main state machine adapted to process a plurality supplemental services; and
a secondary state machine adapted to control the polarity of a transmission line, the secondary state machine being controlled by the main state machine.

9. The gateway of claim 8, further comprising;
a timer manager coupled to the main state machine and the secondary state machine.

10. The gateway of claim 8, further comprising:
a timer converter coupled to the main state machine.

11. The gateway of claim 8, further comprising:
a line reverse controller coupled to the secondary state machine, the line reverse controller adapted to control the polarity of the transmission line.

12. The gateway of claim 8, wherein the plurality of types of supplemental services are selected form a group consisting of dual tone alerting signal (DT-AS), ring pulse alerting signal (RP-AS), line reverse+dual tone alerting signal (LR+DT-AS), line reverse (LR), line reverse+ring pulse alerting signal (LR+RP-AS) and dual tone alerting signal−off hook (DT-AS−Offh).

13. The gateway of claim 8, further comprising:
an event converter adapted to convert received messages based on a type of terminal alerting signal and a select input into unique events for the main state machine;
an action converter adapted to convert select outputs of the main state machine to either a send ring command or a play tone command; and
a line reverse event converter adapted to convert signals from the main state machine into restore and reverse signals that are coupled to the secondary state machine.

14. The gateway of claim 13, further comprising:
a pre-processing controller adapted to compute process variables for the event converter, the action converter and the line reverse converter.

15. A method implementing a voice over IP gateway in a communication system, the method comprising:
supporting a plurality of different types of supplemental services with a single process.

16. The method of claim 15, wherein the single process comprises:
receiving a supplemental service signal;
computing a process variable based on the supplemental service signal;
converting the process variable and a select input into a unique event signal;
processing the unique event signal;
sending a signal to a select terminal equipment based on the processed unique event signal; and
providing associated supplemental service data to the select terminal equipment.

17. The method of claim 15, wherein supporting a plurality of different types of supplemental services with a single process further comprises:
signaling a first type of supplemental services with a first state machine; and
signaling a second type of supplemental services with a second state machine that is synchronized with the first state machine.

18. The method of claim 17, further comprising:
controlling the second state machine with the first state machine.

19. The method of claim 17, wherein the signals used in the signaling of the first type of supplemental services with the first state machine are selected from a group of signals consisting of a dual tone alerting signal (DT-AS) and a ring pulse alerting signal (RP-AS).

20. The method of claim 17, wherein the signal used in signaling the second type of supplemental services with the second state machine is a line reverse (LR) signal.

21. The method of claim 17, further comprising:
sending service data with the first state machine.

22. A method of providing a plurality of supplemental services through a voice over IP gateway, the method comprising:
receiving a supplemental service signal;
computing a process variable based on the supplemental service signal;
converting the process variable and a select input into a unique event signal;
processing the unique event signal;
sending a signal to a select terminal equipment based on the processed unique event signal; and
providing associated supplemental service data to the select terminal equipment.

23. The method of claim 22, further comprising:
acknowledging the signal based on the processed unique event signal.

24. The method of claim 22, wherein the supplemental service signal is selected from a group consisting of dual tone alerting signal (DT-AS), ring pulse alerting signal (RP-AS), line reverse+dual tone alerting signal (LR+DT-AS), line reverse (LR), line reverse+ring pulse alerting signal (LR+RP-AS) and dual tone alerting signal−off hook (DT-AS−Offh).

25. The method of claim 22, wherein processing the unique event further comprises:
outputting the signal based on the event signal and a select state.

26. The method of claim 25, wherein the select states is selected from a group of states consisting of idle, pre-signal (pre-sgn), signal (sgn), wait for acknowledgement (WtAck), pre-data, data and post data.

27. The method of claim 22, wherein processing the unique event further comprises:
using a first state machine adapted to cover DT-AS/RP-AS and data transmission scenarios.

28. The method of claim 27, further comprising:
using a second state machine adapted to cover line reverse signals.

29. The method of claim 28, further comprising:
synchronizing the second state machine with the first state machine.

30. A computer-usable medium having computer-readable instructions stored thereon for execution by a processor to perform a method comprising:
supporting a plurality of different types of supplemental services with a single process.

31. The computer-usable medium of claim 30, wherein the single process comprises:
receiving a supplemental service signal;
computing a process variable based on the supplemental service signal;
converting the process variable and a select input into a unique event signal;
processing the unique event signal;
sending a signal to a select terminal equipment based on the processed unique event signal; and
providing associated supplemental service data to the select terminal equipment.

32. The computer-usable medium of claim 30, wherein supporting a plurality of different types of supplemental services with a single process further comprises:
signaling a first type of supplemental services with a first state machine; and
signaling a second type of supplemental services with a second state machine that is synchronized with the first state machine.

33. The computer-usable medium of claim 32, further comprising:
controlling the second state machine with the first state machine.

34. The computer-usable medium of claim 32, wherein the signals used in the signaling of the first type of supplemental services with the first state machine are selected from a group of signals consisting of a dual tone alerting signal (DT-AS) and a ring pulse alerting signal (RP-AS).

35. The computer-usable medium of claim 32, wherein the signal used in signaling the second type of supplemental services with the second state machine is a line reverse (LR) signal.

36. The computer-usable medium of claim 32, further comprising:
sending service data with the first state machine.
